(19) United States
(12) Patent Application Publication
(10) Pub. No.: US 2012/0151271 A1
(43) Pub. Date: Jun. 14, 2012

(54) MAT-REDUCED SYMBOLIC ANALYSIS

(75) Inventor: Malay GANAI, PRINCETON, NJ (US)

(73) Assignee: NEC Laboratories America, Inc., Princeton, NJ (US)

(21) Appl. No.: 13/316,123

(22) Filed: Dec. 9, 2011

Related U.S. Application Data
(60) Provisional application No. 61/421,673, filed on Dec. 10, 2010.

(51) Int. Cl. G06F 11/36

(52) U.S. Cl. 714/38.1; 714/E11.208

(57) ABSTRACT

A computer implemented testing framework for symbolic trace analysis of observed concurrent traces that uses MAT-based reduction to obtain succinct encoding of concurrency constraints, resulting in quadratic formulation in terms of number of transitions. We also present encoding of various violation conditions. Especially, for data races and deadlocks, we present techniques to infer and encode the respective conditions. Our experimental results show the efficacy of such encoding compared to previous encoding using cubic formulation. We provided proof of correctness of our symbolic encoding.

### CROSS REFERENCE TO RELATED APPLICATIONS

This application claims the benefit of U.S. Provisional Patent Application No. 61/421,673 filed Dec. 10, 2010.

### FIELD OF THE DISCLOSURE

This disclosure relates generally to the field of computer software and in particular to a symbolic analysis technique for determining concurrency errors in computer software programs.

### BACKGROUND OF THE DISCLOSURE

The growth of cheap and ubiquitous multi-processor systems and concurrent library support are making concurrent programming very attractive. However, verification of multi-threaded concurrent systems remains a daunting task especially due to complex and unexpected interactions between asynchronous threads. Unfortunately, testing a program for every interleaving on every test input is often practically impossible.

Runtime-based program analysis infer and predict program errors from an observed trace. As compared to static analysis, runtime analysis often results in fewer false alarms.

Heavy-weight runtime analysis such as dynamic model checking and satisfiability-based symbolic analysis, search for violations in all feasible alternate interleavings of the observed trace and thereby, report a true violation if and only if one exists.

In dynamic model checking, for a given test input, systematic exploration of a program under all possible thread interleavings is performed. Even though test input is fixed, explicit enumeration of interleavings can still be quite expensive. Although partial order reduction techniques (POR) reduce the set of necessary interleavings to explore, the reduced set often remains prohibitively large. Some previous work used ad-hoc approaches such as perturbing program execution by injecting artificial delays at every synchronization points, or randomized dynamic analysis to increase the chance of detecting real races.

In trace-based symbolic analysis, explicit enumeration is avoided via the use of symbolic encoding and decision procedures to search for violations in a concurrent trace program (CTP). A CTP corresponds to data and control slice of the concurrent program (unrolled, if there is a thread local loop), and is constructed from both the observed trace and the program source code. One can view a CTP as a generator for both the original trace and all the other traces corresponding to feasible interleavings of the events in the original trace.

Previously, we have introduced mutually atomic transaction (MAT)-based POR technique to obtain a set of context-switches that allow all and only the representative interleavings. Given its utility, improvements to MAT-reduced symbolic analysis would represent an advance in the art.

### SUMMARY OF THE DISCLOSURE

An advance in the art is made according to an aspect of the present disclosure directed to a MAT reduced symbolic method for analyzing concurrent traces of computer software programs. The method according to the present disclosure advantageously utilizes an alternate encoding based on transaction sequence constraints that advantageously captures all feasible sequencing of a given set of transactions symbolically.

More specifically, a method according to the present disclosure—when given a trace—first obtains a concurrent trace model (CTM). A MAT-based analysis is performed on that model to obtain a set of independent transactions and a set of ordered pairs of independent transactions. An interacting transaction model (ITM) is then built from the set of independent transactions and set of ordered pairs. More specifically, transaction sequence constraints are added to capture the various sequencing of the transactions possible by the ordered pair set. Each transaction is encoded with a symbolic transaction id (tsid) and the transaction sequence constraints advantageously include inter-thread and intra-thread transaction assignments update constraints, and update constraints for tsid.

The encoding ensures that each transaction sequence captured is equivalent to some feasible interleaving of the events, and each feasible interleaving of events has a corresponding transaction sequence. It further guarantees that in any sequence of transactions, each transaction is assigned a unique concrete transaction id.

Furthermore, the encoding produces quantifier-free SMT formula that is of size quadratic in the number of shared access events in the concurrent trace model. Furthermore, the inter-thread transaction sequence constraints produces quantifier-free formula of EUF logic i.e., SMT(EUF) which advantageously leads to smaller and simpler formulas to solve than the prior art approaches.

Our approach generates quantifier-free SMT formula that is quadratic in the size of transactions in the worst case. We also provide proof of correctness of our symbolic analysis. In our experimental section, we compared our method with a previous approach that generates formula that is cubic in the size of transactions in the worst case.

### BRIEF DESCRIPTION OF THE DRAWING

A more complete understanding of the present disclosure may be realized by reference to the accompanying drawings in which:

FIG. 1 depicts: (a) an exemplary concurrent system P with threads Mₐ,M_{b} with local variables a,b, respectively, communicating with shared variables X,Y,Z,L; (b) lattice and a run a, and (c) CTP_{σ} as CCFG, according to an aspect of the present disclosure;

FIG. 2 shows: (a) CCFG with independent transactions and (b) local and non-local interactions according to an aspect of the present disclosure;

FIG. 3 depicts: (a) MATs {m₁, . . . , m₅}, and (b) a run of GenMAT; according to an aspect of the present disclosure;

FIG. 4 shows race condition(s) for (a) race_{<}(t₁,t₂)^{m3}:=E₃ [symbol] E₇ [symbol] B₆ [symbol] C_{3,6}, and race_{<}(t₁,t₂)^{m5}:=E₃ [symbol] E₇ [symbol] B₇ [symbol] C_{3,7}, according to an aspect of the present disclosure; and

FIG. 5 is a schematic showing a deadlock due to cyclic wait on mutex locks according to an aspect of the present disclosure;

FIG. 6 is a schematic digraph with a cycle corresponding to a deadlock condition (t_{LH1,L1}<t_{LH2,L2}<t_{LH3,L3}) && other than L2 no other locks were acquired between L1 and L3 according to an aspect of the present disclosure;

FIG. 7 depicts Table 1 which is a comparison of time taken (in sec) by Symbolic Analysis according to an aspect of the present disclosure;

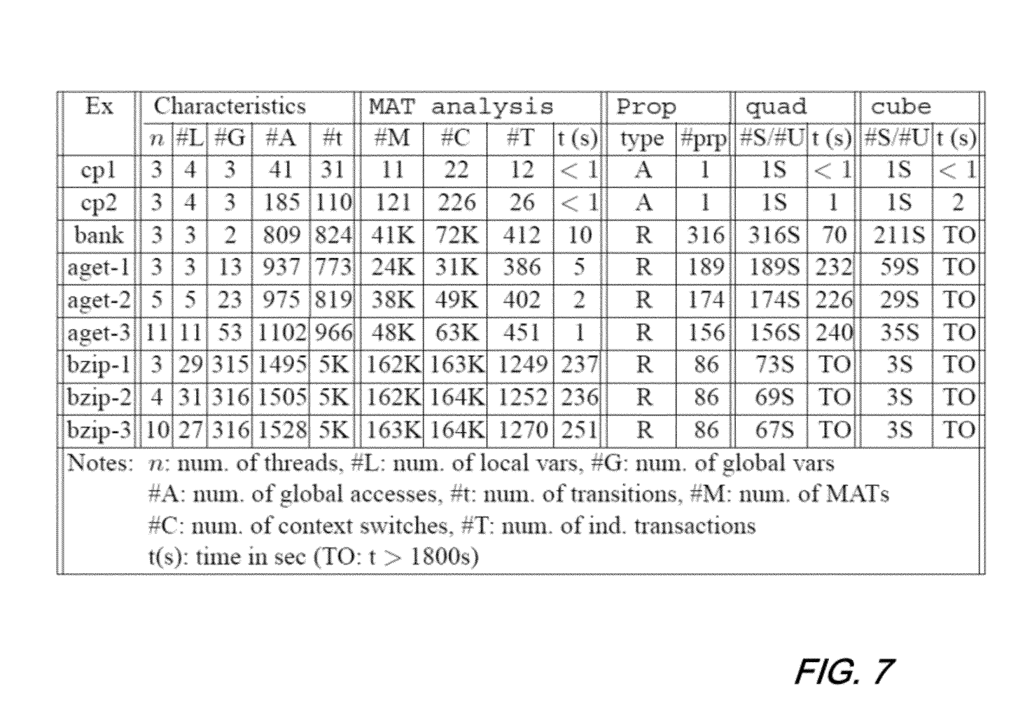

FIG. 8 is a schematic block diagram of a representative computer system which may be employed to implement methods and systems according to an aspect of the present disclosure; and

FIG. 9 is a flow diagram depicting a method according to an aspect of the present disclosure; and

FIG. 10 is a schematic diagram depicting an exemplary operation of the method of the present disclosure operating on a representative computer system.

### DETAILED DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently-known equivalents as well as equivalents developed in the future, i.e., any elements developed that perform the same function, regardless of structure.

Thus, for example, it will be appreciated by those skilled in the art that the diagrams herein represent conceptual views of illustrative structures embodying the principles of the disclosure. Similarly, it will be appreciated that any flow charts, flow diagrams, state transition diagrams, pseudocode, and the like represent various processes which may be substantially represented in computer readable medium and so executed by a computer or processor, whether or not such computer or processor is explicitly shown.

The functions of the various elements shown in the Figures, including any functional blocks labeled as “processors”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

Unless otherwise explicitly specified herein, the drawings are not drawn to scale.

1. Introduction

The growth of cheap and ubiquitous multi-processor systems and concurrent library support are making concurrent programming very attractive. However, verification of multi-threaded concurrent systems remains a daunting task especially due to complex and unexpected interactions between asynchronous threads. Unfortunately, testing a program for every interleaving on every test input is often practically impossible. Runtime-based program analysis infer and predict program errors from an observed trace. Compared to static analysis, runtime analysis often result in fewer false alarms.

Heavy-weight runtime analysis such as dynamic model checking and satisfiability-based symbolic analysis, search for violations in all feasible alternate interleavings of the observed trace and thereby, report a true violation if and only if one exists.

In dynamic model checking, for a given test input, systematic exploration of a program under all possible thread interleavings is performed. Even though the test input is fixed, explicit enumeration of interleavings can still be quite expensive. Althoughpartial order reduction techniques (POR) reduce the set of necessary interleavings to explore, the reduced set often remains prohibitively large. Some previous work used ad-hoc approaches such as perturbing program execution by injecting artificial delays at every synchronization points, or randomized dynamic analysis to increase the chance of detecting real races.

In trace-based symbolic analysis, explicit enumeration is avoided via the use of symbolic encoding and decision procedures to search for violations in a concurrent trace program (CTP). A CTP corresponds to data and control slice of the concurrent program (unrolled, if there is a thread local loop), and is constructed from both the observed trace and the program source code. One can view a CTP as a generator for both the original trace and all the other traces corresponding to feasible interleavings of the events in the original trace.

Previously, we have introduced mutually atomic transaction (MAT)-based POR technique to obtain a set of context-switches that allow all and only the representative interleavings. We now present the details of the MAT-reduced symbolic analysis used in our concurrency testing framework CONTESSA.

Specifically, we first use MAT analysis to obtain a set of independent transactions and their interactions. Using them, we build an interacting transaction model (ITM). Later, we add transaction sequence constraints to ITM to allow all and only total and program order sequence of the transactions. We also add synchronization constraints to capture the read-value property, i.e., read of a variable gets the latest write in the sequence. We encode the concurrency errors such as assertion violations, order violations, data races and deadlocks. For the latter two, we provide mechanisms for inferring the violation conditions from given set of transaction interactions.

Our approach generates quantifier-free SMT formula that is quadratic in the size of transactions in the worst case. We also provide proof of correctness of our symbolic analysis. In our experimental section, we compared our method with a previous approach that generates formula that is cubic in the size of transactions in the worst case.

2. Concurrent System

A multi-threaded concurrent program P comprises a set of threads and a set of shared variables, some of which, such as locks, are used for synchronization. Let Mᵢ (1≦i≦n) denote a thread model represented by a control and data flow graph of the sequential program it executes. Let Vᵢ be a set of local variables in Mᵢ and V be a set of (global) shared variables. Let Cᵢ be a set of control states in Mᵢ. Let [symbol] be the set of global states of the system, where a state s ∈ [symbol] is a valuation of all local and global variables of the system.

A thread transition t is a 4-tuple <c,g,u,c′> that corresponds to a thread Mᵢ, where c, c′ ∈ Cᵢ represent the control states of Mᵢ, g is an enabling condition (or guard) defined on Vᵢ∪V, and u is a set of update assignments of the form v:=exp where variable v and variables in expression exp belong to the set Vᵢ∪V. We use operator next(v) to denote the next state update of variable v.

Let pcᵢ denote a thread program counter of thread Mᵢ. For a given transition t=<c,g,u,c′>, and a state s Å [symbol] , if g evaluates to true in s, and pcᵢ=c, we say that t is enabled in s. Let enabled(s) denote the set of all enabled transitions in s. We assume each thread model is deterministic, i.e., at most one local transition of a thread can be enabled.

The interleaving semantics of concurrent system is a model in which precisely one local transition is scheduled to execute from a state. Formally, a global transition system for P is an interleaved composition of the individual thread models, where a global transition consists of firing of a local transition t E enabled(s) from state s to reach a next state s′, denoted as s→^{t}s′.

A schedule of the concurrent program P is an interleaving sequence of thread transitions ρ=t₁ . . . tₖ. An event e occurs when a unique transition t is fired, which we refer as the generator for that event, and denote it as t=gen(P,e). A run (or concrete execution trace) σ=e₁ . . . eₖ of a concurrent program P is an ordered sequence of events, where each event eᵢ corresponds to firing of a unique transition tᵢ=gen(P,eᵢ). We illustrate the differences between schedules and runs in Section 3.

Let begin(t) and end(t) denote the beginning and the ending control states of t=<c,g,u,c′>, respectively. Let tid(t) denote the corresponding thread of the transition t. We assume each transition t is atomic, i.e., uninterruptible, and has at most one shared memory access. Let Tᵢ denote the set of all transitions of Mᵢ , and [symbol] =UᵢTᵢ be the set of all transitions.

A transaction is an uninterrupted sequence of transitions of a particular thread as observed in a system execution. We say a transaction (of a thread) is atomic w.r.t. a schedule, if the corresponding sequence of transitions are executed uninterrupted, i.e., without an interleaving of another thread in-between. For a given set of schedules, if a transaction is atomic w.r.t. all the schedules in the set, we refer to it as an independent transaction w.r.t. the set. We compare the notion of atomicity used here, vis-a-vis previous works. Here the atomicity of transactions corresponds to the observation of the system, which may not correspond to the user intended atomicity of the transactions. Previous work assume that the atomic transactions are system specification that should always be enforced, whereas here atomic (or rather independent) transactions is inferred from the given system under test, and are used to reduce the search space of symbolic analysis

Given a run σ for a program P we say e happens-before e′, denoted as e [symbol] _{σ} e′ if i<j, where σ[i]=e and σ[j]=e′, with σ[i] denoting the i^{th} access event in σ. Let t=gen(P,e) and t′=gen(P,e′). We say t [symbol] _{σ} t′ if e [symbol] _{σ} e′. For some σ, if e [symbol] _{σ}e′ and tid(t)=tid(t′), we say e [symbol] ₚₒ e′ and t [symbol] ₚₒ t′, i.e., the events and the transitions are in thread program order. If e happens-before e′ always and tid (e)≠tid(e′), we refer to such a relation as must happen-before (or must-HB, in short). We observe such must-HB relations during thread creation, thread-join, and wait-notify. In the sequel, we restrict the use of must-HB to inter-thread events only.

Dependency Relation ( [symbol] ): Given a set T of transitions, we say a pair of transitions (t, t′) ∈ T×T is dependent, i.e. (t, t′) ∈ [symbol] if one of the following holds (a) t [symbol] ₚₒ t′, (b) t must happen-before t′, (c) (t, t′) is conflicting, i.e., accesses are on the same global variable, and at least one of them is a write access. If (t, t′) ∉ [symbol] , we say the pair is independent.

Equivalency Relation (≅): We say two schedules ρ₁=t₁ . . . tᵢ·tᵢ₊₁ . . . tₙ and ρ₂=t₁ . . . tᵢ₊₁·tᵢ . . . tₙ are equivalent if (tᵢ, tᵢ₊₁) ∉ [symbol] . An equivalent class of schedules can be obtained by iteratively swapping the consecutive independent transitions in a given schedule. A representative schedule refers to one of such an equivalent class.

Sequentially consistency: A schedule is sequentially consistent [?] iff (a) transitions of the same thread are in the program order, (b) each shared read access gets the last data written at the same address location in the total order, and (c) synchronization semantics is maintained, i.e., the same locks are not acquired in the run without a corresponding release in between. In the sequel, we also refer to such a sequentially consistent schedule as a feasible schedule.

A data race corresponds to a global state where two different threads can access the same shared variable simultaneously, and at least one of them is a write.

A partial order is a relation R [symbol] [symbol] × [symbol] on a set of transition [symbol] , that is reflexive, antisymmetric, and transitive. A partial order is also a total order if, for all t, t′ ∈ [symbol] , either (t, t′) ∈ R, or (t′, t) ∈ R. Partial order-based reduction (POR) methods [?] avoid exploring all possible interleavings of shared accesses by exploiting the commutativity of the independent transitions. Thus, instead of exploring all interleavings that realize these partial orders it is adequate to explore just the representative interleaving of each equivalence class.

A concurrent trace program with respect to an execution trace σ=e₁ . . . eₖ and concurrent program P, denoted as CT P_{σ}, is a partial ordered set (T_{σ}, [symbol] _{σ,po})

T_{σ}={t|t=gen(P,e) where e ∈ σ} is the set of generator transitions

t [symbol] _{σ,po} t′if t [symbol] ₚₒ t′ ∃ t,t′ ∈ T_{σ}

Let ρ=t₁ . . . tₖ be a schedule corresponding to the run σ, where tᵢ=gen(P,eᵢ). We say schedule ρ′=t′₁, . . . , t′ₖ is an alternate schedule of CT P_{σ} if it is obtained by interleaving transitions of σ as per [symbol] _{σ,po}. We say ρ′ is a feasible schedule iff there exists a concrete trace σ′=e₁′ . . . eₖ′ where tᵢ′=gen(P,eᵢ′).

We extend the definition of CTP over multiple traces by first defining a merge operator that can be applied on two CTPs, CT P_{σ} and CTP_{ψ} as: (T_{τ}, [symbol] _{τ,po})=^{def} where ((T_{σ}, [symbol] _{σ,po}), (T_{ψ}, [symbol] _{ψ,po})), where T_{σ}=T_{σ}∪T_{ψ} and t [symbol] _{τ,po} t′ iff at least one of the following is true: (a) t [symbol] _{σ,po} t′ where t, t′ ∈ T_{σ}, and (b) t [symbol] _{ψ,po} t′ where t,t′ ∈T_{ψ}. A merged CTP can be effectively represented as a CCFG with branching structure but no loop. In the sequel, we refer to such a merged CTP as a CTP.

3. Our Approach: An Informal View

In this section, we present our approach informally, where we motivate our readers with an example. We use that example to guide the rest of our discussion. In the later sections, we give a formal exposition of our approach.

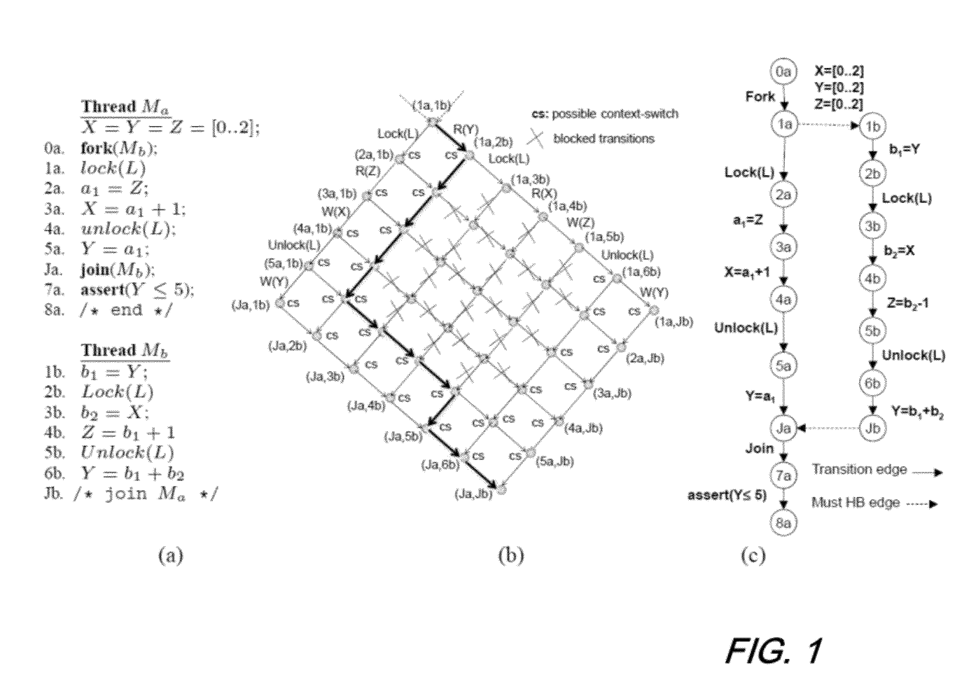

Consider a system P comprising interacting threads Mₐ and M_{b} with local variables aᵢ and bᵢ, respectively, and shared (global) variables X,Y,Z,L. This is shown in FIG. 1(a) where threads are synchronized with Lock/Unlock. Thread M_{b} is created and destroyed by thread Mₐ using fork join primitives. A thread transition (1b, true, b₁=Y, 2b) (also represented as

$$1 b {\to }^{{b}_{1} = Y} 2 b )$$

can be viewed as a generator of access event R (Y)_{b} corresponding to the read access of the shared variable Y.

FIG. 1(b) is the lattice representing the complete interleaving space of the program. Each node in the lattice denotes a global control state, shown as a pair of the thread local control states. An edge denotes a shared event write/read access of global variable, labeled with W(.)/R(.) or Lock(.)/Unlock(.). Note, some interleavings are not feasible due to Lock/Unlock, which we crossed out (×) in the figure. We also labeled all possible context switches with cs. The highlighted interleaving corresponds to a concrete execution (run) σ of program P

$$σ = {R ( Y )}_{b} \cdot {Lock ( L )}_{a } … {Unlock ( L )}_{a} \cdot {Lock ( L )}_{b} … {W ( Z )}_{b} \cdot {W ( Y )}_{a} \cdot {Unlock ( L )}_{b} \cdot {W ( Y )}_{b}$$

where the suffices a,b denote the corresponding thread accesses. The corresponding schedule ρ of the run σ is

$$ρ = ( 1 b {\to }^{{b}_{1} = Y} 2 b ) ( 1 a {\to }^{Lock ( L )} 2 a ) … ( 4 a {\to }^{Unlock ( L )} 5 a ) ( 2 b {\to }^{Lock ( L )} 3 b ) … ( 6 b {\to }^{Y = {B}_{1} + {b}_{2}} Jb )$$

From σ (and ρ), we obtain a slice of the original program called concurrent trace program (CTP). A CTP can be viewed as a generator of concrete traces, where the inter-thread event order specific to the given trace are relaxed. FIG. 1(c) show the CT P_{σ} of the corresponding runσ shown as a CCFG (This CCFG happens to be the same as P, although it need not be the case). Each node in CCFG denotes a thread control state (and the corresponding thread location), and each edge represents one of the following: thread transition, a context switch, a fork, and a join. To not clutter up the figure, we do not show edges that correspond to possible context switches (30 in total). Such a CCFG captures all the thread schedules of CT P_{σ}.

3.1. MAT-Reduced Symbolic Encoding

Given such a CTP, we use MAT-based analysis to obtain independent transactions, and their interactions as order pairs (as described in Section 4). Recall, an independent transaction is atomic with respect to a set of schedules (Section 2). There are two types of transaction interactions: local, i.e., program order and non-local, i.e., inter-thread.

An interaction pair (i,j) is local if transactions i,j correspond to the same thread, and j follows i immediately in a program order. An interaction pair (i,j) is non-local if transactions i and j correspond to different threads, and there is a context switch from the thread local state at the end of the transaction i to the thread local state at the beginning of j.

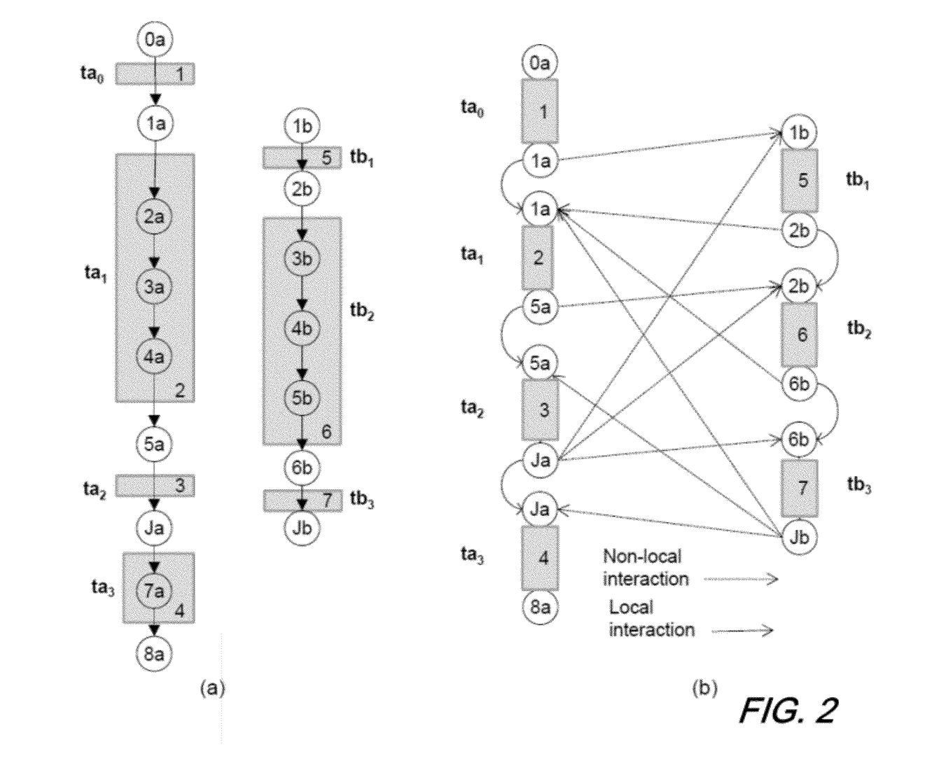

As shown in FIG. 2(a), the independent transactions set corresponding to thread Mₐ and M_{b} are ATₐ={ta₀,ta₁,ta₂,ta₃}, and AT_{b}={tb₁,tb₂,tb₃}, respectively. Their local interactions are the ordered pairs: (ta₀,ta₁) , (ta₁,ta₂) , (ta₂,ta₃), (tb₁,tb₂) , (tb₂,tb₃) , and non-local interactions are the ordered pairs: (ta₁, tb₂), (ta₂,tb₁) , (ta₂, tb₂), (ta₂,tb₃), (tb₁,ta₁), (tb₂,ta₁), (tb₃,ta₁), (tb₃,ta₂), (ta₀,tb₁), and (tb₂,ta₃). Note that last two non-local interactions arise due to must-HB relation.

The sequential consistency requirement imposes certain restriction in the combination of these interactions. Total order requirement does not permit any cycles in any feasible path. For example, a transaction sequence ta₁·tb₂·ta₁ is not permissible as it has cycle. Program order requirement is violated in a sequence ta₁·tb₂·tb₃·ta₂·tb₁, although it is a total ordered sequence. As per the interleaving semantics, any schedule can not have two or more consecutive context switches. In other words, there is an exclusive pairing of transactions in a sequence where each transaction can pair with at most one transaction before it and after it in the sequence.

The MAT-reduced symbolic analysis is conducted in four phases: In the first phase, for a given CTP, MAT-analysis is used to identify a subset of possible context switches such that all and only representative schedules are permissible. Using such analysis, a set of so-called independent transactions and their local/non-local interactions are generated.

In the second phase, an independent transaction model (ITM) is obtained, where each transaction is decoupled from the other. We introduce new symbolic variable for each global variable at the beginning of each transaction. This independent modeling is needed to symbolically pair consecutive transactions.

In the third phase, transaction sequence constraint is added to allow only total and program order sequence based on their interactions. In addition, synchronization constraints are added to synchronize the global variables between the non-local transactions, and local variables between the local transactions. Further, update constraints are added corresponding to the update assignment in a transition.

In the fourth phase, we encode the conditions for checking the concurrency errors such as assertion violation, order violation, data races and deadlocks.

The constraints added result in a quantifier-free SMT formula, which is given to a SMT solver to check for its satisfiability. If the formula is satisfiable, we obtain a sequentially consistent trace that violates the condition; otherwise, we obtain a proof that violation is not satisfiable. We give details of the various phases of the encoding in the following sections.

4. Phase I: MAT-Based Partial Order Reduction

For a given CTP, there could be many must-HB relation. In such cases, we separate the interacting fragments of threads at the boundary of corresponding transitions, so that each fragment, denoted as IF, does not have any must HB relation. MAT-analysis is then conducted on each such fragment separately.

In the given example (FIG. 1(c)), the transition (0a, true, f ork(M_{b}),1a) must happen-before the transition (1b, true, b₁=Y,2b), and similarly, the transition (6b, true, Y=b₁+b₂,Jb) must happen before the transition (Ja,true,Join(M_{b}),7). These must-HB relations partition the CTP in three fragments: IF₁,IF₂ and IF₃ where IF₁ is between (0a,-) and (1a,1b), IF₂ is between (1a,1b) and (Ja,Jb), and IF₃ is between (Ja,Jb) and (8a,-). Note, IF₂ is the only interesting fragment with thread interactions.

In the following, we discuss MAT-analysis for IF₂. Later, we discuss the consolidation of these results for the CTP.

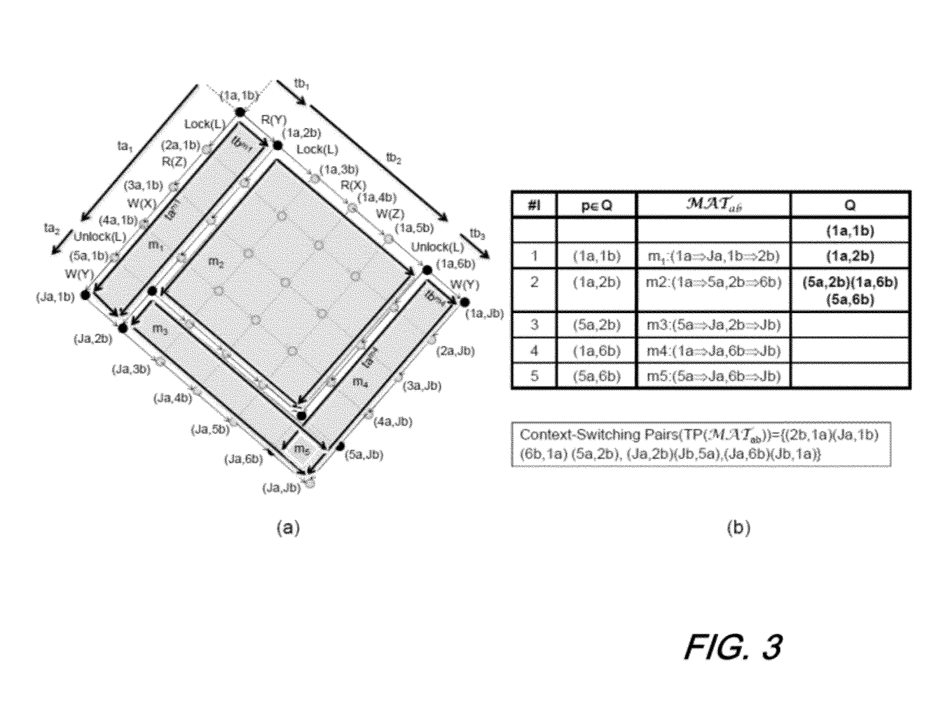

Consider a pair (ta^{m}^{₁},tb^{m}^{₁}), shown as the shaded rectangle m₁ in FIG. 3(a), where ta^{m}^{₁}≡Lock(L)ₐ·R(Z)ₐ . . . W(Y)ₐ and tb^{m}^{₁}≡R(Y)_{b} are transactions of threads Mₐ and M_{b}, respectively. For the ease of readability, we use an event to imply the corresponding generator transition.

Note that from the control state pair (1a,1b), the pair (Ja,2b) can be reached by one of the two representative interleavings ta^{m}^{₁}·tb^{m}^{₁} and tb^{₁}·ta^{m}^{₁}. Such a transaction pair (ta^{m}^{₁},tb^{m}^{₁}) is atomic pair-wise as one avoids interleaving them in-between, and hence, referred as Mutually Atomic Transaction, MAT for short [?]. Note that in a MAT only the last transition pair have shared accesses on the same variable, maybe co-enabled, and at least one of them being write. Other MATs m₂ . . . m₅ are similar. In general, transactions associated with different MATs are not mutually atomic. For example, ta^{m}^{₁} in m₁ is not mutually atomic with tb^{m}^{₃} in m₃ , where tb^{m}^{₃}≡Lock(L)_{b} . . . W(Y)_{b}.

The basic idea of MAT-based partial order reduction is to restrict context switching only between the two transactions of a MAT. A context switch can only occur from the ending of a transaction to the beginning of the other transaction in the same MAT. Such a restriction reduces the set of necessary thread interleavings. For a given MAT α=(fᵢ . . . lᵢ, fⱼ . . . lⱼ), we define a set TP(α) of possible context switches as ordered pairs, i.e., TP(α)={(end(lᵢ), begin(fⱼ)), (end(lⱼ), begin(fᵢ)))}. Note that there are exactly two context switches for any given MAT.

Let TP denote a set of possible context switches. For a given interacting fragment IF, we say the set TP is adequate iff for every feasible thread schedules of the IF there is an equivalent schedule that can be obtained by choosing context switching only between the pairs in TP. Given a set [symbol] of MATs, we define TP( [symbol] )= [symbol] TP(α). A set [symbol] is called adequate iff TP( [symbol] ) is adequate. For a given IF, one can use an algorithm GenMAT (not shown) to obtain an adequate set of [symbol] that allows only representative thread schedules, as claimed in the following theorem. GenMAT generates a set of MATs that captures all (i.e., adequate) and only (i.e., optimal) representative thread schedules. (For the interacting fragments of the threads). Further, its running cost is O(n²·k²), where n is number of threads,and k is the maximum number of shared accesses in a thread.

The GenMAT algorithm on the running example proceeds as follows. It starts with the pair (1a,1b), and identifies two MAT candidates: (1a . . . Ja, 1b·2b) and (1a·2a, 1b . . . 6b). By giving M_{b} higher priority over Mₐ, it selects a MAT uniquely from the MAT candidates. The choice of M_{b} over Mₐ is arbitrary but fixed throughout the MAT computation, which is required for the optimality result. After selecting MAT m₁, it inserts in a queue Q, three control state pairs (1a,2b), (Ja,2b), (Ja,1b) corresponding to the begin and the end pairs of the transactions in m₁. These correspond to the three corners of the rectangle m₁. In the next step, it pops out the pair (1a,2b)∈ Q, selects MAT m₂ using the same priority rule, and inserts three more pairs (5a,2b), (5a,6b), (1a,6b) in Q. Note that MAT (1a . . . 5a,2b·3b) is ignored as the interleaving 2b·3b·1a . . . 5a is infeasible. Note that if there is no transition from a control state such as Ja, no MAT is generated from (Ja,2b). The algorithm terminates when all the pairs in the queue (denoted as in FIG. 3(a)) are processed.

We present the run of GenMAT in FIG. 3(b). The table columns provide each iteration step (#I), the pair p ∈ Q selected, the chosen [symbol] _{ab}, and the new pairs added in Q (shown in bold).

Note that the order of pair insertion in the queue can be arbitrary, but the same pair is never inserted more than once. For the running example, a set [symbol] _{ab}={m₁, . . . m₅} of five MATs is generated. Each MAT is shown as a rectangle in FIG. 3(a). The total number of context switches allowed by the set, i.e., TP( [symbol] _{ab}) is 8.

The highlighted interleaving (shown in FIG. 1(b)) is equivalent to the representative interleaving tb^{m}^{₁}·ta^{m}^{₁}·tb^{m}^{₃}. One can verify (the optimality) that this is the only representative schedule (of this equivalence class) permissible by the set TP( [symbol] _{ab}).

### 4.1. MAT Analysis for CTP

For each pair of threads in CTP, we obtain a set of interacting fragments. Let [symbol] denote the set of all interacting fragments. For a given IFᵢ ∈ [symbol] , let TPᵢ denote the set of context switches as obtained by above MAT-analysis on IFᵢ. If IFᵢ does not have interacting threads, then TPᵢ=Ø. Corresponding to each must-HB relation between IFᵢ and IFⱼ, denoted as IFᵢ [symbol] IFⱼ, let (cᵢ, cⱼ) denote an ordered pair of non-local control states such that cᵢ must happen before cᵢ. We obtain a set of context-switches for CTP, denoted as TP_{CTP}, as follows:

$${TP}_{CTP} = {⋃}_{{IF}_{i} ∈ 𝒥ℱ} {TP}_{i} ⋃ {⋃}_{{IF}_{i} ≺ {IF}_{j}} ( {c}_{i} , {c}_{j} ) \qquad ( 1 )$$

The set TP_{CTP} (obtained in Eqn. 1) captures all and only representative schedules of CTP.

Discussion. Partitioning the CTP into interacting fragments is an optimization step to reduce the set of infeasible context switches due to must-HB relation. We want to ensure that MAT-analysis does not generate such context switches in the first place. Clearly, such partitioning does not affect the set of schedules captured, although it reduces TP_{CTP} significantly.

For the running example, the set of context switches, denoted as TP_{CTP} obtained is given by TP( [symbol] _{ab})∪{(1a,1b)(Jb,Ja)}. Such a set of transaction interactions captures all and only representative thread schedules.

5. Phase II: Independent Transaction Model

A control state c is said to be visible if either (c,c′) ∈TP_{CTP} or (c′,c) ∈ TP_{CTP}, i.e., either there is a context switch to c or from c, respectively; otherwise it is invisible.

Given TP_{CTP}, we obtain a set of independent transactions of a thread Mᵢ, denoted as ATᵢ , by splitting the sequence of program ordered transitions of Mᵢ into transactions only at the visible control states, such that a context switching can occur either to the beginning or from the end of such transactions of the independent transaction

For the running example, the sets ATₐ and AT_{b} are: ATₐ={ta₀=0a . . . 1a,ta₁=1a . . . 5a,ta₂=5a·Ja,ta₃=Ja . . . 8a} and AT_{b}={tb₁=1b·2b,tb₂=2b . . . 6b,tb₃=6b·Jb}, as shown in FIG. 2(a). We also number each transaction as shown in the boxes for our later references. For the interacting thread fragment i.e., IF₂, we show them as outlines of the lattice in FIG. 3(a).

The local and non-local interactions of these independent transactions, corresponding to TP_{CTP}, shown in the FIG. 2(b), are as follows:

local: (ta₀,ta₁), (ta₁,ta₂), (ta₂,ta₃), (tb₁,tb₂), (tb₂,tb₃),

non-local: (ta₁,tb₂), (ta₂,tb₁), (ta₂,tb₂), (ta₂,tb₃), (tb₁,ta₁), (tb₂,ta₁), (tb₃,ta₁), (tb₃,ta₂), (ta₀,tb₁), and (tb₂,ta₃).

We use gv, to denote the symbolic value of a global variable gv ∈ V at some local control state c. Similarly, we use lv_{c} to denote the symbolic value of local variable at c. At the begin control state c of each transaction, we introduce a new symbolic variable, denoted as gv_{c}? corresponding to each global variable gv. This variable replaces any subsequent use of gv_{c} in an assignment with in the transaction. Thus, we obtain an independent transaction model where each transaction is decoupled from another transaction.

Based on the transaction interactions, we constrain the introduced symbolic variable gv_{c}? at the beginning of a transaction to a symbolic value gv_{c}′ at the end of a preceding transaction in some feasible transaction sequence.

6. Phase III: Concurrency Constraints

Given independent transaction model (ITM), obtained as above, we add the concurrency constraints to capture inter- and intra-transaction dependencies due to their interactions, and thereby, eliminate additional non-determinism introduced. These constraints, denoted as Ω, comprise of two main components:

Ω:=Ωn_{TS} [symbol] Ω_{SYN} (2)

where Ω_{TS} corresponds to constraints for sequencing transactions in a total and program order, and Ω_{SYN} corresponds to synchronization (value update) constraints between transactions, and within a transaction.

6.1. Transaction Sequencing

The transaction sequence constraints Ω_{TS} has three components:

Ω_{TS}:=Ω_{TI} [symbol] Ω_{TO} [symbol] Ω_{PO} (3)

where Ω_{TI} encodes the transaction interaction, Ω_{TO} encodes the total ordering of transactions, and Ω_{PO} encodes the program order of the transactions. To ease the presentation, we use the following notations/constants for a given transaction i Å 1 . . . n.
beginᵢ,endᵢ: the begin/end control state of i respectively
tidᵢ: the thread id of i
c_inᵢ, c_outᵢₙ: a set of transactions (of different thread) which can possibly context switch to/from i, respectively.
nc_inᵢ,nc_outᵢ: a set of transactions (of same thread) which immediately precedes/follow i thread locally.
eᵢⱼ: unique constant value for a transaction pair (i,j) ∈ TP_{CTP}

We introduce following symbolic variables. (Note, small letters denote integer variables, and capitalize letters denote Boolean variables).
idᵢ: id of transaction i
Cᵢⱼ: Boolean flag denoting context switching from transaction i to j such that tidᵢ≠tidⱼ and (i,j) E TP_{CTP}
NC_{i,j}: Boolean flag denoting program order sequence from transaction i to j such that i ∈ nc_inⱼ (or j ∈ nc_outᵢ) (i.e., endᵢ=beginⱼ)
Bᵢ, Eₜᵢ : Boolean flag denoting the transaction i has started/completed execution, i.e., beginᵢ/endᵢ is reached respectively.
srcᵢ: variable taking values from the set U_{(i,j)∈TP}_{_{CTP}}e_{i,j}
dstᵢ: variable taking values from the set U_{(j,i)∈TP}_{_{CTP}}e_{j,i}
   We construct Ω_{TI},Ω_{TI},Ω_{PO} as follows. Let i=1 be source transaction, i.e., nc _inᵢ=c_inᵢ=Ø. Similarly, let i=n be the sink transaction, i.e., nc_outₙ=c_outₙ=Ø.
Transaction Interaction (Ω_{TI}): Let Ωₜᵢ:=true initially. For each transaction i ∈ 2 . . . n (i.e., not a source), we add

$${Ω}_{TI} := {Ω}_{TI} ⋀ ( {B}_{i} -> {⋁}_{j ∈ {c\_in}_{i}} ( {C}_{j , i} ⋀ {E}_{j} ) ⋁ {⋁}_{k ∈ {nc\_in}_{i}} ( {NC}_{k , i} ⋀ {B}_{k} ) ) \qquad ( 4 )$$

For each transaction i ∈ 1 . . . n−1 (i.e., not a sink), we add

$${Ω}_{TI} := {Ω}_{TI} ⋀ ( {E}_{i} -> {⋁}_{j ∈ {c\_out}_{i}} ( {C}_{i , j} ⋀ {B}_{j} ) ⋁ {⋁}_{k ∈ {nc\_out}_{i}} ( {NC}_{i , k} ⋀ {B}_{k} ) ) \qquad ( 5 )$$

6.1. Transaction Sequencing

Total ordering (Ω_{TO}): For total ordering in transaction sequence, we need the following two mutual exclusivity: (a) at most one finished transaction is sequenced preceding i, i.e., at most one of C_{j,i}'s and NC_{k,i}'s literals be asserted, (b) at most one enabled transaction is sequenced following i, i.e., at most one of C_{i,j}'s and NC_{k,i}'s literals be asserted.

We achieve this by introducing new symbolic variables srcᵢ and dstᵢ to constrain C_{i,j} and NC_{i,j} as follows:

Let Ω_{TO}:=true initially. For each transaction pair (i,j) ∈ TP_{CTP} and tidᵢ≠tidⱼ, let

$${Ω}_{TO} := {Ω}_{TO} ⋀ ( {C}_{i , j} ↔ ( {src}_{i} = {e}_{i , j} ⋀ {dst}_{j} = {e}_{i , j} ⋀ ( {id}_{i} + 1 = {id}_{j} ) ) ) \qquad ( 6 )$$

For each transaction pair (i,j) ∈ TP_{CTP} and tidᵢ=tidⱼ, let

$${Ω}_{TO} := {Ω}_{TO} ( {NC}_{i , j} ↔ ( {src}_{i} = {e}_{i , j} ⋀ {dst}_{j} = {e}_{i , j} ⋀ ( {id}_{i} + 1 = {id}_{j} ) ) ) \qquad ( 7 )$$

Note that the constraint Ω_{TO} ensures that for distinct i,j,k,k′, Cₜᵢ→ [symbol] C_{i,k} [symbol] [symbol] NC_{i,k′}, and NC_{i,j}→ [symbol] C_{i,k}wedge [symbol] NC_{i,k′} holds.

The mutual exclusion obtained using the auxiliary variables srcᵢ and dstᵢ results in the constraints of size quadratic in the size of transaction pairs in the worst case.
1. Program order (Ω_{PO}): Let (Ω_{PO}):=true initially. For each transaction pair (i,j) ∈ TP_{CTP} tidᵢ≠tidⱼ, i.e., with a program order edge, let

Ω_{PO}:=Ω_{PO} [symbol] (idᵢ<idⱼ) (8)

2. For each transaction j,

$${Ω}_{PO} := ( {E}_{j} -> {B}_{j} ) ⋀ ( {B}_{j} -> {⋁}_{i ∈ {nc\_in}_{j}} {B}_{i} ) \qquad ( 9 )$$

3. We say a transaction is complete iff Bᵢ=true , Eᵢ=true. and a transaction is incomplete iff Bᵢ=true,Eᵢ=false. A transaction has not started iff Bᵢ=false.

Let [symbol] be a set of m≦n complete and incomplete transactions allowed by the constraints ≠_{TS}. We claim that there exists a unique sequence π of m transaction where πᵢ ∈ [symbol] denoting the i^{th} transaction in the sequence such that id_{π}_{ᵢ}+1=id_{π}_{ᵢ₊₁} for 1≦i≦m, and if nc_in_{π}_{ᵢ}≠Ø there exists 1≦i′<i such that πᵢ′ ∈ nc_in_{π}_{ᵢ}).

6.1.1. Cubic Encoding

As is known, total ordering may be achieved using happens-before constraint, requiring cubic formulation. Let HB(i,j) denote that i has happened before j i.e., idᵢ<idⱼ. We construct the total ordering constraints, denoted as Ω_{TO}, using happens before constraint. When a transaction j follows i, we want to make sure that all other transactions are not between i and j.

Let Ω′_{TO}:=true initially. For each transaction pair (i,j)∈TP_{CTP} tidᵢ≠tidⱼ, let

$${Ω}_{TO}^{′} := {Ω}_{TO}^{′} ⋀ ( {C}_{i , j} ↔ ( {id}_{1} + 1 = {id}_{j} ) ) ⋀ {⋀}_{k \neq i , j} ( HB ( k , i ) ⋁ HB ( j , k ) ) \qquad ( 10 )$$

For each transaction pair (i,j) ∈TP_{CTP} tidᵢ=tidⱼ, let

$${Ω}_{TO}^{′} := {Ω}_{TO}^{′} ⋀ ( {NC}_{i , j} ↔ ( {id}_{i} + 1 = {id}_{j} ) ) ⋀ {⋀}_{k \neq i , j} ( HB ( k , i ) ⋁ HB ( j , k ) ) ) \qquad ( 11 )$$

One observes that the constraint Ω′_{TO} achieves mutual exclusion with constraints of size cubic in the size of transaction pairs in the worst case.

6.2. Synchronization

In this section, we discuss the synchronization constraints that are added between transactions i.e., inter and within transactions, i.e., intra to maintain read-value property.

The synchronization constraints Ω_{SYN} has two components:

Ω_{SYN}:=Ωᵢₙₜᵣₐ [symbol] Ωᵢₙₜₑᵣ (12)

where Ωᵢₙₜᵣₐ encodes the update constraints with in a transaction, and Ωᵢₙₜₑᵣ encodes the synchronization constraints across transactions.

For each transition t=(c,g,u,c′) that appear in some transaction, we introduce the following notations:
PC_{c}: Boolean flag denoting pcᵢ=c i.e., thread i at local control state c.
lv_{c}: symbolic value of a local variable lv at control state c.
gv_{c}: symbolic value of a global variable gv at control state c.
gv_{c}?: new symbolic variable corresponding to a global variable gv introduced at visible control state c.
Gₜ/Gₜ?: guarded symbolic expression corresponding to g(t) in terms of lv_{c}'s and gv_{c}'s at invisible/visible state c, respectively.
uₜ/uₜ?: update symbolic expression, a conjunction of (v_{c′}=exp) for each assignment expression (v:=exp) in u(t) where v is a variable, and exp is in terms lv_{c}'s and gv_{c}'s at invisible/visbile control state c, respectively.

We construct Ωᵢₙₜᵣₐ as follows: Let Ωᵢₙₜᵣₐ:=true. For each transition t=(c,g,u,c′) such that c is visible,

Ωᵢₙₜᵣₐ:=Ωᵢₙₜᵣₐ [symbol] (Gₜ? [symbol] PC_{c}→uₜ? [symbol] PC_{c′}) (13)

For each transition t=(c,g,u,c′) such that c is invisible,

Ωᵢₙₜᵣₐ:=Ωᵢₙₜᵣₐ [symbol] (Gₜ [symbol] PC_{c}→uₜ [symbol] PC_{c′}) (14)

For every transaction i beginning and ending at c,c′ respectively,

Ωᵢₙₜᵣₐ:=Ωᵢₙₜᵣₐ [symbol] (Bᵢ [symbol] PC_{c}) [symbol] (Eᵢ [symbol] PC_{c′}) (15)

We now construct Ωᵢₙₜₑᵣ to synchronize the global variables across the transactions. Let Ωᵢₙₜₑᵣ:=true. For each transaction pair (i,j) ∈ TP_{CTP} tidᵢ≠tidⱼ and endᵢ and beginⱼ representing the ending/beginning control states of i and j, respectively, let

$${Ω}_{inter} := Ωinter ⋀ ( {C}_{i , j} -> {⋀}_{gv ∈ v} ( {gv}_{{end}_{i}} = {gv}_{{begin}_{j}} ? ) \qquad ( 16 )$$

Similarly, for (i,j) ∈ TP_{CTP} tidᵢ≠tidⱼ, we have

$${Ω}_{inter} := Ω inter ⋀ ( {NC}_{i , j} -> {⋀}_{gv ∈ V} ( {gv}_{{end}_{i}} = {gv}_{{begin}_{j}} ? ) \qquad ( 17 )$$

7. Phase IV: Encoding Violations

We discuss encoding four types of violations: assertion, order, data races, and deadlocks. For the latter two, we also discuss mechanism to infer violation conditions from a given CTP.

The concurrency violation constraints, denoted as Ω_{V}, is then added to the concurrency constraints.

Ω:=Ω_{TS} [symbol] _{SYN} [symbol] Ω_{V} (18)

In the following section, the constraints Ω_{V} corresponds to assertion violation Ωₐᵥ, order violation Ω_{ord}, data races Ω_{race} and deadlocks Ω_{deadlock}, respectively.

7.1. Assertion Violation

An assertion condition is associated with a transition t=(c,g,u,c′) where g is the corresponding condition. A assertion violation av occurs when PC_{c} is true and g(t) evaluates to false. We encode the assertion violation Ωₐᵥ as follows:

Ωₐᵥ:=PC_{c} [symbol] [symbol] G (19)

where G is Gₜ if c is invisible; other wise G is Gₑ?.

7.2. Order Violation

Given two transitions t, t′ (of different threads) such that t should happen before t′ in all interleaving, one encodes the order violation condition, i.e., t′ [symbol] t by constraining the transaction sequence where transaction with transition t′ occurs before the transaction with transition t. Let x(t) denote a set of transactions where transition t occurs. We encode the order violation condition, denoted as ord(t′,t), as follows:

$${Ω}_{ord ( {t}^{′} , t )} := {⋁}_{i ∈ x ( {t}^{′} ) , j ∈ x ( t )} {E}_{i} ⋀ {E}_{j} ⋀ ( id ( i ) < id ( j ) ) \qquad ( 20 )$$

Note, in case t,t′ are non-conflicting, we explicitly declare them conflicting to allow MAT analysis to generate corresponding context-switches.

7.3. Data Races

The date race conditions, i.e., transition pairs l,l′ with a simultaneous conflicting accesses, denoted as race (l,l′), can be inferred by identifying a subsequence of transactions where (a) l occurs before l′, denoted as race [symbol] (l,l′) (b) and for any transition l″ between l and l′ (l,l″) ∉ [symbol] . Similarly, we use [symbol] (l,l)) to denote where l′ occurs before l.

We first identify a MAT α=(f . . . l, f′ . . . l′) such that l and l′ have conflicting accesses on shared variables. Note, if no such MAT α exists, then the race condition race (l,l′) does not exist, as guaranteed by the Theorem 3.

Let f . . . l be divided into a sequence of 1≦k independent transactions π₁ . . . πₖ, where πᵢ represent the i^{th} transaction. Similarly, let f′ . . . l′ be divided into a sequence of k′ independent transactions π′₁ . . . π′_{k′}. Note, the transition l occurs in πₖ and l′ occurs in π′_{k′}.

For such a MAT α, we obtain a race condition, denoted as [symbol] (l,l′), as follows:

$${Ω}_{{race}_{≺} ( l , {l}^{′} )}^{α} : {⋁}_{i = 1}^{{k}^{′}} {E}_{{{π}^{′}}_{{k}^{′}}} ⋀ {E}_{{π}_{k}} ⋀ {C}_{{π}_{k} , {π}_{i}^{′}} ⋀ {B}_{{π}_{i}^{′}} ⋀ {⋀}_{j = i}^{k - 1} ( {NC}_{{π}_{j}^{′} , {π}_{j + 1}^{′}} ) \qquad ( 21 )$$

A race condition occurs when context switch πₖ to π′ᵢ 1≦i≦k′ occurs (provided (πₖ,π_{i′}) ∈ TP_{CTP}), and the transaction sequence π′ᵢ . . . π′_{k′} remains uninterrupted.

For 2-thread system, it can be shown that when context switch πₖ to π′ᵢ is asserted, the transaction sequence π′ᵢ . . . e′ₖ remains uninterrupted. Therefore, for 2-thread system, we can simplify the above race condition (l′l) as:

$${Ω}_{{race}_{≺} ( l , {l}^{′} )}^{α} : {⋁}_{i = 1}^{{k}^{′}} {E}_{{{π}^{′}}_{{k}^{′}}} ⋀ {E}_{{π}_{k}} ⋀ {C}_{{π}_{k} , {π}_{i}^{′}} ⋀ {B}_{{π}_{i}^{′}} \qquad ( 22 )$$

Similarly, we encode the race condition [symbol] Finally, we obtain the race condition for race(l,l′) as disjunction over all such MATs, i.e.,

$$\begin{matrix}{Ω}_{race ( l , {l}^{′} )} := {Ω}_{{race}_{≺} ( l , {l}^{′} )} ⋁ {Ω}_{{race}_{≻} ( l , {l}^{′} )} \\ where & ( 23 ) \\ {Ω}_{{race}_{≺} ( l , {l}^{′} )} := {⋁}_{α ∈ TP ( ℳ𝒜𝒯} {Ω}_{{race}_{≺} ( l , {l}^{′} )}^{α} & ( 24 ) \\ {Ω}_{{race}_{≻} ( l , {l}^{′} )} := {⋁}_{α ∈ TP ( ℳ𝒜𝒯 )} {Ω}_{{race}_{≻} ( l , {l}^{′} )}^{α} & ( 25 )\end{matrix}$$

As Eqn 23 is a disjunctive formula, one can solve each disjunction separately until the condition satisfies for some transaction sequence. Note, each disjunction also partitions the interleaving space exclusively.

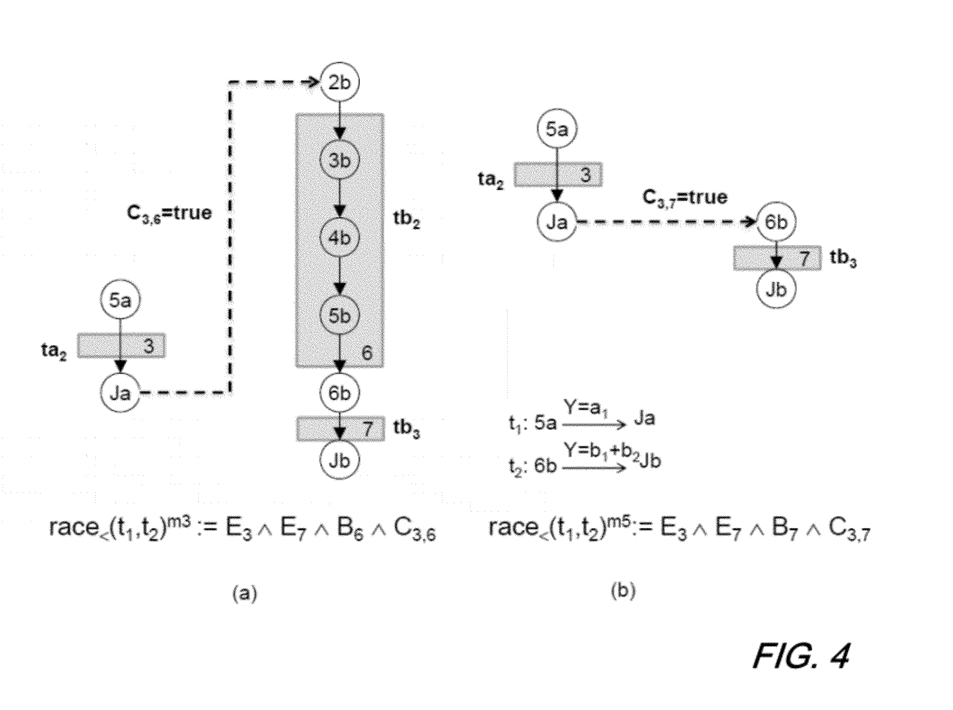

Example. For the running example, we obtain the race condition between the transition t=(5a,true,Y=a₁,Ja) and t′=(6b,true,Y=b₁+b₂,Jb), as shown in FIG. 4. There are three MATs m₃,m₄,m₅ that correspond to the conflicting accesses between t and t′. We obtain the race conditions as disjunction of following conditions:

[symbol]

=E₃ [symbol] E₇ [symbol] B₆ [symbol] C_{3,6} (26)

[symbol]

=E₃ [symbol] E₇ [symbol] B₇ [symbol] C_{3,7} (27)

[symbol]

=E₇ [symbol] E₃ [symbol] B₂ [symbol] C_{7,2} (28)

[symbol]

=E₃ [symbol] E₇ [symbol] B₃ [symbol] C_{7,3} (29)

The constraint [symbol] is same as [symbol] and [symbol] is same as [symbol] , and therefore, we do not show separately.

7.4. Deadlock

In the following, we consider the deadlock conditions created by mutex locks, i.e., when two or more threads form a circular chain where each thread waits for a mutex lock that the next thread in the chain holds.

To accommodate detecting of such condition, we first build a digraph using the given CTP. The digraph consists of three types of vertices:
a vertex corresponding to a lock, denoted as L
a vertex corresponding to a transition where L is acquired, denoted as t_{LH,L} where LH is the set of locks held (by the corresponding thread locally) at the beginning of the transition, and L ∉ LH.
a vertex corresponding to a transition, denoted as t_{LH,L}⁻ whose next transition is t_{LH,L}.

There are three kinds of directed edges:
a directed edge, denoted as acq from lock L to transition t_{LH,L} denoting that L is acquired.
a directed edge, denoted as wait from a transition t_{LH,L}⁻ to L denoting the next local transition, i.e., t_{LH,L} is waiting for L.
a directed edge, denoted as held, from t_{LH,L} to t⁻LH′,L′ if t_{LH,L} [symbol] t_{LH′,L′}⁻ and L ∈ LH′, i.e., L is still held.

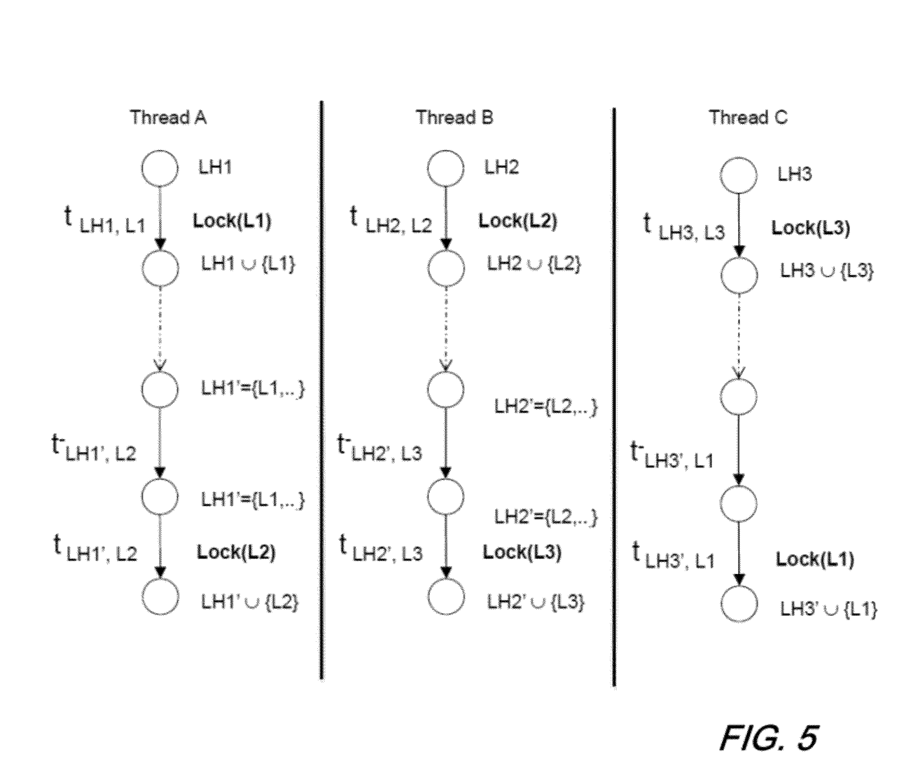

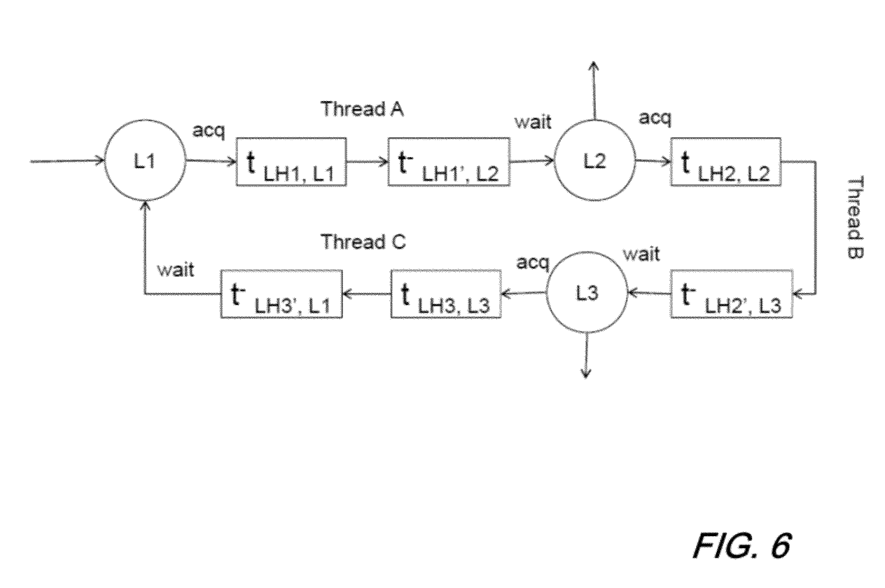

Example. Consider three threads A, B, C as shown in FIG. 5. Thread A acquires lock L1, followed by L2. Similarly, thread B acquires lock L2 followed by L3, and thread C acquires lock L3 followed by L1. We build a diagraph as shown in FIG. 6, where we each round vertex represents a lock resource, and each box vertex represents a transition that is either acquiring or waiting for a lock. The edges are labeled to denote the dependency relationship of each node with the other.

Each cycle in the digraph corresponds to a deadlock condition. Proof Let the cycle be L₁·t_{LH}_{₁}_{,L}_{₁}·t_{LH}_{₁}_{′,L}_{₂}·L₂ . . . Lᵢ·t_{LH}_{ᵢ}_{,L}_{ᵢ}·t_{LH}_{ᵢ}_{40 ,L}_{ᵢ}⁻·Lᵢ₊₁ . . . Lₙ·t_{LH}_{ₙ}_{,L}_{ₙ}·t_{LH}_{ₙ}_{′,L}_{₁}·L₁. Each transition t_{LH}_{ᵢ}_{′,L}_{ᵢ}, yet to start, is waiting for the lock Lᵢ which is currently unavailable as is acquired by transaction t_{LH}_{ᵢ}_{,Li}. Clearly, the cycle represents a circular chain of waits for mutex locks, and therefore, corresponds to a deadlock condition.

Size of the graph. The number vertices of the graph is bounded by the number of mutex locks and number of transitions acquiring mutex locks. The number of edges are bounded by the quadratic number of transition acquiring mutex locks.

Let π represent a sequence of n transitions t_{LH}_{₁}_{,L}_{₁}, . . . t_{LH}_{ᵢ}_{,L}_{ᵢ} . . . t_{LH}_{ₙ}_{,L}_{ₙ} that corresponds to a cycle in the graph. Let πᵢ=t_{LH}_{ᵢ}_{,L}_{ᵢ}.

For cycle detection efficiently in our framework, we introduce a global variable acnt to keep a count on number of times any locking transition occurs in an interleaving. At every lock acquiring transition, we make the assignment acnt:=acnt+1. We use acnt_{π}_{ᵢ} to denote the count on number of times any lock is acquired by completion of the transition πᵢ. For each such π, we encode the corresponding deadlock condition

$${Ω}_{deadlock ( π )} : {⋀}_{i = 1}^{n - 1} {Ω}_{ord ( {π}_{i} , {π}_{i + 1} )} ⋀ ( {acnt}_{{π}_{i}} + 1 = {actn}_{{π}_{i + 1}} ) \qquad ( 30 )$$

where Ω_{ord(π}_{ᵢ}_{,π}_{ᵢ₊₁}₎ (given by Eqn 20) encodes that the transition πᵢ happens before πᵢ₊₁, and there is no other lock acquisition in between the consecutive transitions in π.

Note that the global variable acnt ensures that every pair of lock acquiring transitions are in conflict. This will guarantee that MAT analysis generates sufficient context switching to capture all possible ordering of locking interleaving.

8. Proof of Correctness

All completed and incomplete transactions allowed by Ω_{TS} forms a unique total ordered and program ordered sequence.

Proof. We prove the lemma by claiming certain properties of the complete and incomplete transactions, represented by the set [symbol] , allowed by Ω_{TS} in the following.

Unique id. We claim that two transactions i·j ∈ [symbol] have unique id. We show by contradiction. Assume idᵢ=idⱼ. As per Eqn. 4, there exist a unique complete transaction i′ such that C_{i′,i}=true or NC_{i′,i}=true, and id(i)=id (i′)+1.

Similarly, there exist a unique complete transaction j′ such that C_{j′,j}=true or NC_{j′,j}=true and id(j)=id(j′)+1. As per Eqn. 567, i′≠j′.

By applying the Eqn. 4, we obtain complete transactions that happened before i′ until nc_in_{i′}=c_in_{i′}=Ø. Similarly, we continue with j′ until nc_in_{j′}=c_in_{j′}=Ø. As per Eqn. 567, i′≠j′. However, since there is only one source transaction, i′=j′=1, we obtain a contradiction.

Unique last transaction: Let i ∈ [symbol] be a transaction such that idᵢ=maxⱼidⱼ. As per the uniqueness property, such a transaction i is unique.

We claim that the i is the last transaction of the sequence. If i is the sink transaction, it is trivial. If i≠n, as per Eqn. 5, there exists either a unique complete transaction j with idⱼ=idᵢ+1 such that C_{i,j}=true, or a unique complete local transaction k such that NC_{i,k}=true (but not both). If j ∈ [symbol] , then idᵢ<idⱼ, which is false as idᵢ is the maximum.

As there is a unique last transaction, all transactions j≠i ∈ [symbol] are complete. The transaction i can be complete or incomplete transaction.

Total order. Having established that i is the last transaction, we show a unique total order sequence by construction.

As per Eqn. 4, there exist a unique complete transaction i′ such that C_{i′,i}=true or NC_{i′,i}=true and id(i)=id(i′)+1. We continue with i′ until i′=1, i.e., source transaction. Thus, we obtain a total order sequence π of transactions 1 . . . i.

Inclusive: We claim that all complete and incomplete transactions are included in the total ordered sequence π=1 . . . i. We show by contradiction. Assume for some k ∈ [symbol] , k is not in the sequence π. Then we have either idₖ<id₁ or idₖ>idᵢ. We can show idₖ>id₁ by constructing sequence of complete and incomplete transactions 1 . . . k. We disprove idₖ>idᵢ as idᵢ is the maximum. Thus, all transactions in [symbol] are included in the sequence.

Program order. We claim that total ordered sequence π is also program ordered. Given a complete transaction j such that nc_inⱼ≠Ø, there exists some i ∈ nc_inⱼ such that Bᵢ=true (Eqn. 9). Clearly, the transaction i is a complete transaction as Eᵢ=B ⱼ=true, and is included in the sequence π. As per Eqn. 8, idᵢ<idⱼ. Thus, the sequence π is also program-ordered.

For a given set of transactions and their interactions, any total ordered and program ordered sequence of transactions starting with source transaction is allowed by Ω_{TS}. Proof. Let π:=π₁ . . . πₘ be such a sequence. We show that π is allowed by Ω_{TS} by finding a witness assignments.

For each transaction πᵢ, we assign B_{π}_{ᵢ}=true and idᵢ=i, and for q ∉ {π₁ . . . πₘ}, B_{q}=false. For 1≦i<m, we assign E_{π}_{ᵢ}=true. If πₘ is complete, we assign E_{π}_{ₘ}=true other wise E_{π}_{ₘ}=false.

For each transaction pair πᵢ,πᵢ₊₁, 1≦i<m, we assign C_{π}_{ᵢ}_{,π}_{ᵢ₊₁}=true if tid_{π}_{₁}≠tid_{π}_{ᵢ₊₁}; otherwise we assign NC_{π}_{ᵢ}_{,π}_{ᵢ₊₁}=true. These assignments satisfy the Eqn. 45 6789. Therefore, π is allowed by the constraint Ω_{TS}.

Any sequence of complete and incomplete transactions allowed by the constraint Ω_{TS} [symbol] Ω_{SYN} is sequentially consistent. Proof As per Lemma 8, each allowed sequence of complete and incomplete transactions are total ordered and program ordered. The synchronization constraints Ωᵢₙₜₑᵣ make sure that the read of global variable gets the latest write in the total ordered sequence, and the update constraints Ωᵢₙₜᵣₐ make sure the local updates are done in program order sequence. The claim follows.

9. Related Work

We survey various SMT-based symbolic approaches to generate efficient formulas to check for bounded length witness traces. Specifically, we discuss related bounded model checking (BMC) approaches that use decision procedures to search for bounded length counter-examples to safety properties such data races and assertions. BMC has been successfully applied to verify real-world designs. Based on how verification models are built, symbolic approaches can be broadly classified into two categories: synchronous (i.e., with scheduler) and asynchronous (i.e., without scheduler).

9.1. Synchronous Models

In this category of symbolic approaches, a synchronous model of a concurrent program is constructed with a scheduler. Such a model is constructed based on interleaving (operational) semantics, where at most one thread transition is scheduled to execute at a time. The scheduler is then constrained—by guard strengthening—to explore only a subset of interleavings. Verification using bounded model checking (BMC) comprises unrolling such a model for a certain depth, and generating SAT/SMT formula with the property constraints.

To guarantee correctness (i.e., cover all necessary interleavings), the scheduler must allow context-switch between accesses that are conflicting, i.e., accesses whose relative execution order can produce different global system states. One determines conservatively which pair-wise locations require context switches, using persistent/ample set computations. One can further use lock-set and/or lock-acquisition history analysis, and conditional dependency to reduce the set of interleavings need to be explored (i.e., remove redundant interleavings).

Even with the above-mentioned state reduction methods, the scalability problem remains. To overcome that, some researchers have employed sound abstraction [ with bounded number of context switches (i.e., under-approximation), while others have used finite-state model abstractions, combined with proof-guided method to discover the context switches.

In another approach, an optimal reduction in interleaved state space is achieved for two threaded system, which was extended for a multi-threaded system in [?]. Note, these approaches achieve state space reduction at the expense of increased BMC formula size.

9.2. Asynchronous Models

In the synchronous modeling-based state-reduction approaches, the focus has been more on the reduction of state space, and not so much on the reduction of model size. The overhead of adding static constraints to the formula seems to abate the potential-benefit of less state-space search. Many of the constraints are actually never used, resulting in wasted efforts.

There is a paradigm shift in model checking approaches where the focus is now on generating efficient verification conditions without constructing a synchronous models, and that can be solved easily by the decision procedures. The concurrency semantics used in these modeling are based on sequential consistency. In this semantics, the observer has a view of only the local history of the individual threads where the operations respect the program order. Further, all the memory operations exhibit a common total order that respect the program order and has the read value property, i.e., the read of a variable returns the last write on the same variable in that total order. In the presence of synchronization primitives such as locks/unlocks, the concurrency semantics also respects the mutual exclusion of operations that are guarded by matching locks. Sequential consistency is the most commonly used concurrency semantics for software development due to ease of programming, especially to obtain correctly synchronized threads.

Asynchronous modeling paradigm has advantages over synchronous modeling, and have been shown to suit better for SAT/SMT encoding. To that effect, the symbolic approaches such as CSSA-based (Concurrent Static Single Assignment) and token-based generate verification conditions directly without constructing a synchronous model of concurrent programs, i.e., without using a scheduler. The concurrency constraints that maintain sequentially consistency are included in the verification conditions for a bounded depth analysis.

Specifically, in the CSSA-based approach, read-value constraints are added between each read and write accesses (on a shared variable), combined with happens-before constraints ordering other writes (on the same variable) relative to the pair. Context-bounding are also added to reduce the interleavings to be explored in the verification conditions.

In the token-based approach, a single-token system of decoupled threads is constructed first, and then token-passing and memory consistency constraints are added between each pair of accesses that are shared in the multi-threaded system. The constraints ensures a total order in the token passing events so that the synchronization of the localized (shared) variables takes place at each such event. Such a token-based system guarantees completeness, i.e., only allows traces that are sequentially consistent, and adequacy i.e., captures all the interleavings present in the original multi-threaded system. For effective realization, the constraints are added lazily and incrementally at each BMC unrolling depth,and thereby, reduced verification conditions are generated with a guarantee of completeness and adequacy. For further reduction of the size of the verification conditions, the approach uses lockset analysis to reduce the pair-wise constraints between the accesses that are provably unreachable (such as by static analysis).

A state-reduction based on partial-order technique has been exploited in the token-based modeling approach to exclude the concurrency constraints that allow redundant interleavings, and thereby, reduce the search space and the size of the formula.

Known model checkers such as SPIN, Verisoft, Zing explore states and transitions of the concurrent system using explicit enumeration. They use state reduction techniques based on partial order methods and transactions-based methods. These methods explore only a subset of transitions (such as persistent set, stubborn set), and sleep set) from a given global state. One can obtain a persistent set using conservative static analysis. Since static analysis does not provide precise dependency relation (i.e., hard to obtain in practice), a more practical way would be to obtain the set dynamically. One can also use a sleep set to eliminate redundant interleaving not eliminated by persistent set. Additionally, one can use conditional dependency relation to declare two transitions being dependent with respect to a given state. In previous works, researchers have also used lockset-based transactions to cut down interleaving between access points that are provably unreachable. Some of these methods also exploit the high level program semantics based on transactions and synchronization to reduce the set of representative interleavings.

Symbolic model checkers such as BDD-based SMV, and SAT-based BMC use symbolic representation and traversal of state space, and have been shown to be effective for verifying synchronous hardware designs. There have been some efforts to combine symbolic model checking with the above mentioned state-reduction methods for verifying concurrent software using interleaving semantics. To improve the scalability of the method, some researchers have employed sound abstraction with bounded number of context switches, while some others have used finite-state model or Boolean program abstractions with bounded depth analysis. This is also combined with a bounded number of context switches known a priori or a proof-guided method to discover them.

There have been parallel efforts to detect bugs for weaker memory models. As is known, one can check these models using axiomatic memory style specifications combined with constraint solvers. Note, though these methods support various memory models, they check for bugs using given test programs.

10. Experiment

We have implemented our symbolic analysis in a concurrency testing tool CONTESSA. For our experiments, we use several multi-threaded benchmarks of varied complexity with respect to the number of shared variable accesses. There are 4 sets of benchmarks that are grouped as follows: simple to complex concurrent programs (cp), our Linux/Pthreads/C implementation bank benchmarks (bank), public benchmark (age t) and (b zip). Each set corresponds to concurrent trace programs (CTP) from the runs of the corresponding concurrent programs.

Our experiments were conducted on a linux workstation with a 3.4 GHz CPU and 2 GB of RAM. From these benchmarks, we first obtained CCFG. Then we obtained independent transaction model ITM after conducting MAT analysis on the CCFGs, using GenMAT as described in Section 5.

For benchmarks cp, we selected an assertion violation condition. For the remaining benchmarks, we inferred data races conditions automatically as discussed in Section 7.3.

We used the presented symbolic encoding, denoted as quad, to generate quantifier-free SMT formula with the error conditions. We compared it with our implementation of cubic formulation, denoted as cubic, proposed earlier. We used SMT solver Yices-1.0.28. For each benchmark, we provided a time limit of 1800 s to the SMT solver.

We present the comparison results in Table 1. Column 1 lists the benchmarks. The characteristics of the corresponding CTPs are shown in Columns 2-6 as follows: the number of threads (n), the number of local variables (#L), the number of global variables (#G), the number of global accesses (#A), and the number of total transitions (#t), respectively. The results of MAT-analysis are shown in Columns 7-10 as follows: the number of MATs (#M), the number of context switch edges (#C), the number of transaction edges (#T), and the time taken (t, in sec).

The type and number of error conditions to check are shown in the Columns 10-11 respectively. Type A refers to assertion violation and R refers to data race condition.

The result of quad is shown in Columns 12-13 as follows: number of violations resolved where S /U denote satisfiable/unsatisfiable instances, and time taken (t, in sec).

We found some known and unknown data races in the application aget and bzip using our framework. In age t application, one of the data race (not known before) causes the application to print garbled output. In bzip, one of the data race (not known before) results in the use of variable in a different thread before it was initialized in another thread.

In our comparison result, we observe that quad encoding provides a significant boost to the performance of the solver, as compared to cubic encoding. This shows the efficacy of our encoding.

11. Conclusion

We have presented details of symbolic trace analysis of observed concurrent traces use in our testing framework. Our symbolic analysis uses MAT-based reduction to obtain succinct encoding of concurrency constraints, resulting in quadratic formulation in terms of number of transitions. We also present encoding of various violation conditions. Especially, for data races and deadlocks, we present techniques to infer and encode the respective conditions. Our experimental results show the efficacy of such encoding compared to previous encoding using cubic formulation. We provided proof of correctness of our symbolic encoding. In conclusion, we believe that better encoding will improve the scalability of symbolic technique and, therefore, will improve the quality of concurrency testing.

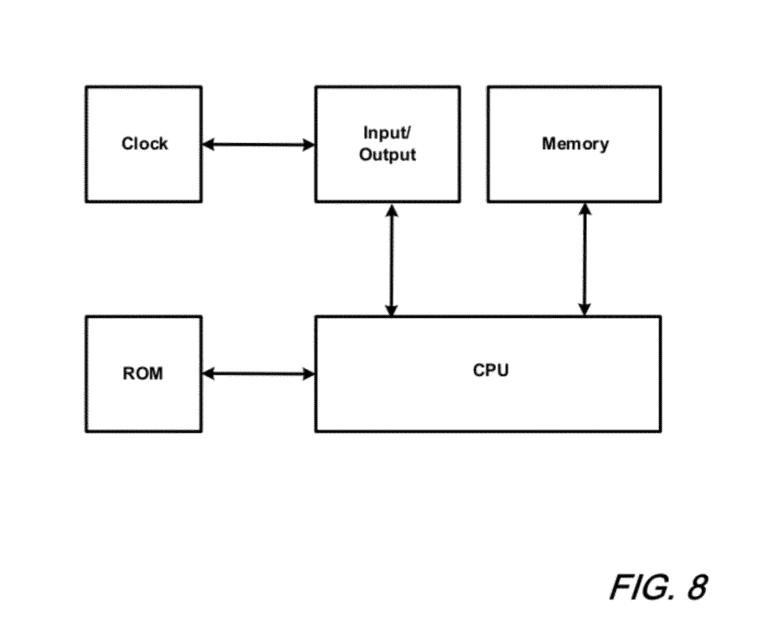

At this point, while we have discussed and described exemplary embodiments and configurations of MAT based symbolic analysis according to an aspect of the present disclosure, those skilled in the art will appreciate that such systems and methods may be implemented on computer systems such as that shown schematically in FIG. 8 and that a number of variations to those described are possible and contemplated.

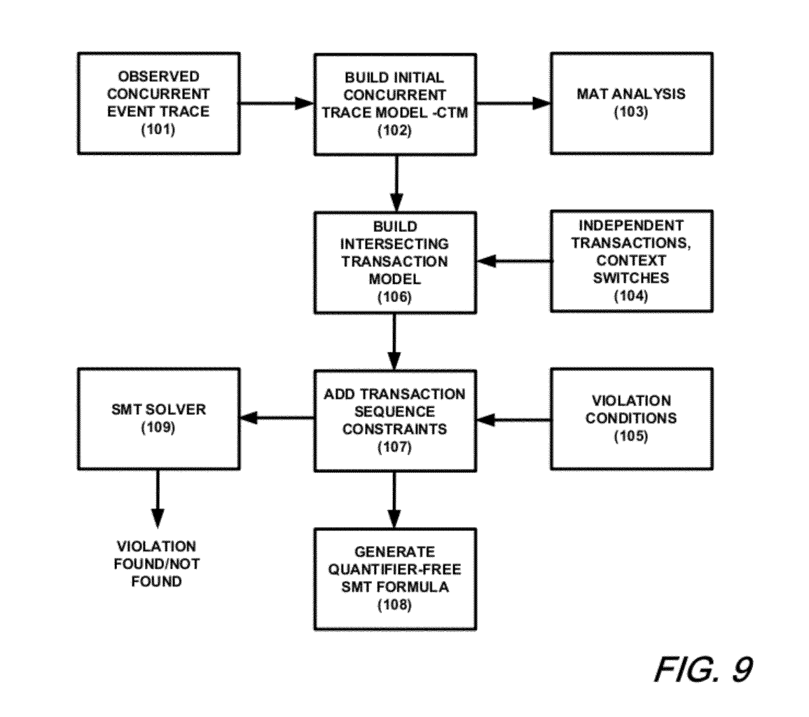

Once implemented on a computer system such as that shown in FIG. 8, a method according to the present disclosure may be made operational. A flow diagram depicting such a computer implemented method is shown in FIG. 9.

With reference to that FIG. 9, given an observed concurrent event trace (block 101) corresponding to an execution of a concurrent program, the trace information is used to build an initial concurrent trace model (CTM) (block 102). A MAT analysis is performed on the CTM (block 103) to obtain a set of independent transactions and a set of ordered pairs between the independent transactions—referred to as context switches (block 104).

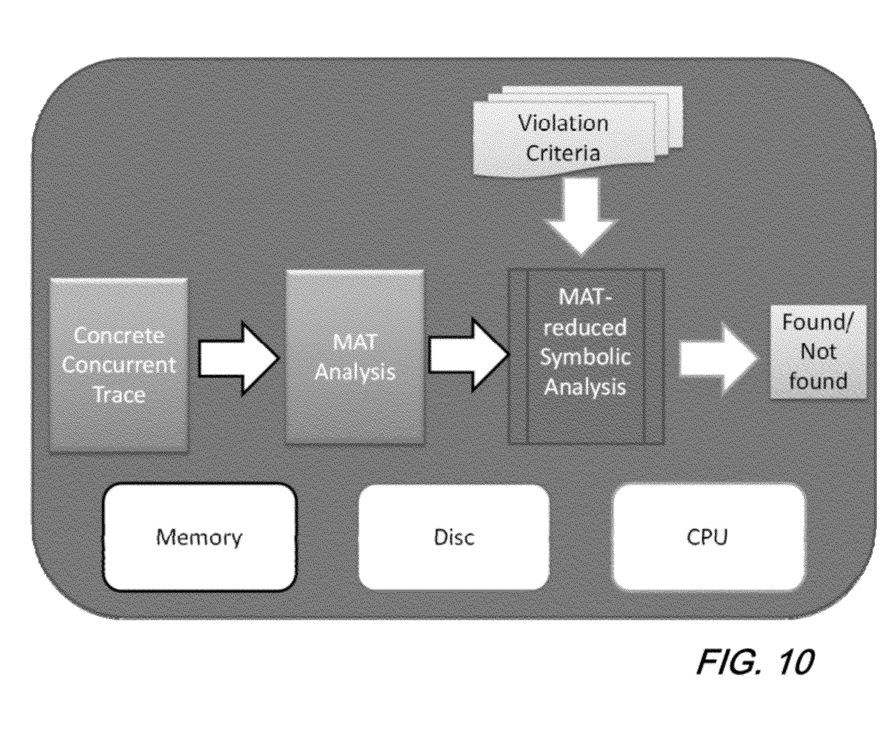

Next, using violation conditions (block 105), a symbolic encoding (blocks 106-108) is performed thereby capturing all feasible interleaved sequences of the transactions. More particularly, an interacting transaction model (ITM) is constructed (block 106). Then a set of transaction sequence constraints are added (block 107). A quantifier-free SMT formula is generated (block 108) such that the formula is generated if and only if there is a sequence of transactions that satisfies the violation condition(s). The encoded formula is provided to a SMT solver to check the satisfiability of violation conditions (block 109) and any such indications may then be output. As may be readily appreciated, a method such as that which is the subject of the present disclosure may advantageously be performed upon/with a contemporary computer such as that shown previously. Operationally, the interaction is exemplary shown in FIG. 10 wherein the computer system operates upon a concrete concurrent trace, performs a MAT analysis, uses a set of violation criteria and performs a MAT-reduced symbolic analysis to determine whether violations are found or not.

With these principles in place, this disclosure should be viewed as limited only by the scope of the claims that follow.

1. A computer implemented method for identifying concurrency errors in concurrent software programs comprising the steps of:
constructing an initial concurrent trace model (CTM) from an observed concurrent event trace of the concurrent software program;
obtaining a set of independent transactions and a set of ordered pairs between the independent transactions by performing a mutually atomic transaction (MAT) analysis on the CTM;
constructing an interacting transaction model (ITM) from the set of independent transactions and the set of ordered pairs of independent transactions;
adding a set of transaction sequence constraints to the ITM;
generating a quantifier-free satisfiability modulo theory (SMT) formula such that the formula is generated if and only if there is a sequence of transactions that satisfies any violation condition(s);
determining the satisfiability of the violation conditions through the effect of a SMT solver on the SMT formula; and
outputting any indicia of violations.

2. A computer implemented method according to claim 1, wherein the transaction sequence constraints comprise transaction ordering constraints and data synchronization constraints between consecutive transactions such that any sequence permissible by the transaction sequence constraints satisfies the relative ordering of the transactions and that any data read from a memory address is the last data written at that memory address.

3. The computer implemented method according to claim 1 wherein the set of independent transactions and set of ordered pairs of independent transactions are obtained such that each feasible interleaving of events has a corresponding feasible transaction sequence.

4. The computer implemented method of claim 1 wherein the transaction sequence constraints are expressed as quantified free EUF logic constraints.
